(19) United States
(12) Patent Application Publication
(10) Pub. No.: US 2015/0199724 A1
(43) Pub. Date: Jul. 16, 2015

(54) MANAGING INVENTORY OVERBOOKING AND SMOOTHING

(71) Applicants: Silvestru Cosmin Negruseri, Mountain View, CA (US); Timothy Andrew James, San Francisco, CA (US); Jeffrey D. Oldham, San Jose, CA (US); Barbara Stanley, Palo Alto, CA (US); Cliff Stein, Tenafly, NJ (US)

(72) Inventors: Silvestru Cosmin Negruseri, Mountain View, CA (US); Timothy Andrew James, San Francisco, CA (US); Jeffrey D. Oldham, San Jose, CA (US); Barbara Stanley, Palo Alto, CA (US); Cliff Stein, Tenafly, NJ (US)

(73) Assignee: GOOGLE INC., Mountain View, CA (US)

(21) Appl. No.: 13/604,350

(22) Filed: Sep. 5, 2012

(51) Int. Cl. G06Q 30/02

(52) U.S. Cl. CPC G06Q 30/0264

(57) ABSTRACT

A system, storage device, or method can provide fair allocation of advertising resources. In some implementations, a method can include identifying multiple advertisement slots, each of the advertisement slots being associated with a capacity constraint. The method can include receiving multiple advertisement reservations, each of the advertisement reservations requesting advertisement impressions at one or more of the advertisement slots. The method can include allocating a quantity of advertisement impressions to each advertisement reservation. The method can include calculating an overbooking score for each advertisement reservation. The overbooking score indicates a degree at which the advertisement reservation is satisfied by the quantity of advertisement impressions allocated to the advertisement reservation. A higher overbooking score indicates a lower degree of satisfaction. The method can include adjusting the quantity of the advertisement impressions allocated to each advertisement reservation so as to minimize a maximum overbooking score while maintaining a maximum total allocation.

### TECHNICAL FIELD

This disclosure relates to online advertising.

### BACKGROUND

Online advertising can include a form of promotion that uses the Internet or other publicly available communications networks for distributing marketing messages to attract customers. Examples of online advertising include contextual advertisements displayed on search results web pages, banner advertisements, rich media advertisements, online social advertising, online classified advertising, and e-mail marketing. Some online advertising provides opportunities for advertisers to serve their advertisements to a more appropriate or receptive audience. Oftentimes, advertisements served to selected users are more likely to be useful to the selected users than advertisement served to general users are useful to the general users.

### SUMMARY

In general, one aspect of the subject matter described in this specification can be embodied in a method for providing fair allocation of advertising resources. The method includes identifying multiple advertisement slots, each of the advertisement slots being associated with a capacity constraint, the capacity constraint including a limit on number of advertisement impressions that will be displayed at the advertisement slot. The method includes receiving multiple advertisement reservations, each of the advertisement reservations requesting advertisement impressions at one or more of the advertisement slots. The method includes allocating, based on capacity constraints of the advertisement slots, a quantity of advertisement impressions to each of the advertisement reservations. The method includes calculating an overbooking score for each of the advertisement reservations. The overbooking score indicates a degree at which the advertisement reservation is satisfied by the quantity of advertisement impressions allocated to the advertisement reservation. A higher overbooking score indicates a lower degree of satisfaction. The method includes adjusting the quantity of the advertisement impressions allocated to each advertisement reservation so as to minimize a maximum overbooking score while maintaining a maximum total allocation, the maximum total allocation including a sum of the quantity of advertisement impressions allocated to each advertisement reservation.

In some implementations, the capacity constraint corresponds to a projected number of advertisement impressions that will be displayed at the advertisement slot. The maximum total allocation can be a maximum number of advertisement impressions that can be allocated to the advertisement reservations, given the capacity constraints and a quantity of advertisement impressions requested by each advertisement reservation. The overbooking score can be determined based at least in part on a ratio between a quantity of advertisement impressions requested by the advertisement reservation and the quantity of advertisement impressions allocated to the advertisement reservation.

In some implementations, adjusting the quantity of the advertisement impressions allocated to each advertisement reservation can include performing the operations including determining a critical value indicating a limit of adjustment that, if exceeded, the maximum total allocation will decrease; identifying a lowest overbooking score for advertisement reservations that have not reached the critical value; and, based at least in part on the critical value and the lowest overbooking score, diverting advertisement impressions allocated to one or more other advertisement reservations to the least satisfied advertisement reservation.

In some implementations, determining the critical value can include representing the advertisement reservations, advertisement allocations, and advertisement slots in a directional graph. In the graph, the advertisement allocations can be represented as flows on edges of the graph; and the capacity constraints can be represented as flow limitations of the edges of the graph. Determining the critical value can include determining an overbooking score for each of the advertisement reservations, the overbooking score indicating a degree at which the advertisement reservation is satisfied by the quantity of advertisement impressions allocated to the advertisement reservation and adjusting the quantity of the advertisement impressions allocated to each advertisement reservation so as to minimize a maximum overbooking score while maintaining a maximum total allocation, the maximum total allocation including a sum of the quantity of advertisement impressions allocated to each advertisement reservation. A higher overbooking score indicates a lower degree of satisfaction.

In some implementations, the critical value is a minimum required amount of flow on an edge of the graph, wherein an increase of the minimum required amount of flow on the edge causes the maximum total allocation to decrease. Adjusting the quantity of the advertisement impressions allocated to the advertisement reservation can include performing operations including: adjusting at least one of the flow limitations based on the overbooking score; and adjusting the quantity of the advertisement impressions based on the adjusted flow limitation.

In some implementations, allocating the quantity of the advertisement impressions to each of the advertisement reservations can include performing a maximum flow analysis on a directional graph representing the advertisement reservations, the advertisement slots, and advertisement impressions projected to be available through each of the advertisement slots.

In some implementations, the method for providing fair allocation of advertising resources can include, in response to an availability query, providing for display a value representing the adjusted quantity of the advertisement impressions. Determining the overbooking score for each of the advertisement reservations and adjusting the quantity of the advertisement impressions allocated to each advertisement reservation can be performed iteratively.

These and other embodiments can be implemented to achieve the following advantages. Advertisers will see their advertisement reservations satisfied more consistently and fairly. As the most unfair advertisement impression allocations are adjusted if possible, an advertisement that would otherwise be obscured due to poor allocation can have a better opportunity to be presented to selected users. The advertisement reservations can be distributed more evenly among various advertisement slots and among targeted audiences. For example, an advertisement serving three different audiences has a better opportunity to be distributed evenly among the three different audiences rather than being delivered to only one of the three audiences.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF DRAWINGS

FIG. 1 is a schematic diagram illustrating an example system for managing an online advertisement inventory.

FIG. 2 is a block diagram illustrating subsystems of an example advertisement management system for managing an online advertisement inventory.

FIG. 3 is a flowchart illustrating an example process of managing inventory overbooking

FIG. 4 is a flowchart illustrating an example process of iteratively minimizing a maximum overbooking score.

FIG. 5 is a flowchart illustrating an example process of adjusting the quantity of the advertisement impressions allocated to an advertisement reservation.

FIGS. 6A-6C are example inventory allocation graphs illustrating example stages of managing inventory overbooking.

FIG. 7A is a flowchart illustrating an example process of allocation smoothing.

FIG. 7B is a flowchart illustrating an example process of iteratively maximizing a minimum smoothness score.

FIG. 7C is a flowchart illustrating an example process of adjusting the quantity of the advertisement impressions allocated to each advertisement reservation.

FIGS. 8A-8D are example inventory allocation graphs illustrating example stages of managing allocation smoothing.

Like reference numbers and designations in the various drawings indicate like elements.

### DETAILED DESCRIPTION

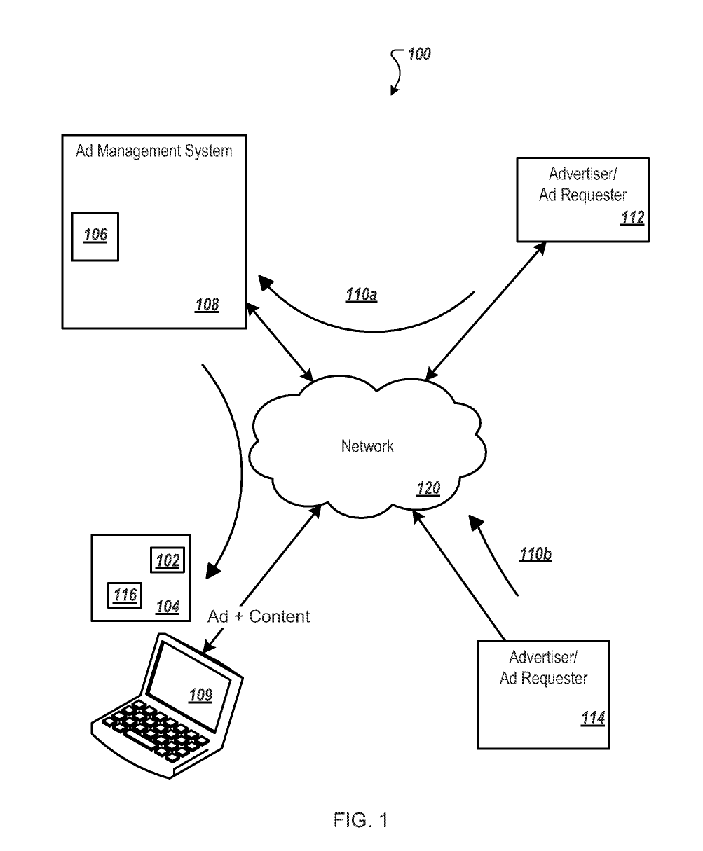

FIG. 1 is a schematic diagram illustrating an example system 100 for managing an online advertisement inventory. The online advertisement inventory includes projected number of times advertisements are displayed at various advertisement slots. An advertisement slot 102 is a place on a web page 104 where an advertisement 106 is displayed at a user device 109. The advertisement slot 102 can be associated with a display size and a specified location where the advertisement 106 will appear on the web page 104.

The system 100 includes an advertisement management system 108. The advertisement management system 108 includes one or more data processing devices configured to receive advertisement reservations 110a and 110b from advertiser 112 and 114, respectively, through a communications network 120. Advertisement reservations 110a and 110b each requests a number of advertisement impressions to be displayed at advertisement slot 102. An advertisement impression is an occurrence that advertisement 106 is displayed at the user device 109. Upon receiving the advertisement reservations 110a and 110b, the advertisement management system 108 allocates the advertisement inventory to advertisement reservations 110a and 110b based on the number of advertisement impressions requested in the advertisement reservations 110a and 110b, and the advertisement inventory. The advertisement management system 108 can allocate the advertisement inventory using flow calculation techniques to maximize the amount of inventory allocated.

The advertisement inventory can be allocated in multiple ways, e.g., by using maximum flow calculations. A conventional maximum flow technique may not guarantee fairly allocation of the advertisement inventory between advertisement reservations 110a and 110b. For example, all advertisement inventory can be allocated to advertisement reservation 110a, while advertisement reservation 110b receives nothing. In addition, a result of the maximum flow calculations may allocate advertisement inventory unevenly among multiple advertisement slots. For example, a reservation on advertisement slot 102 and advertisement slot 116 may get all impressions from advertisement slot 102 but none from advertisement slot 116.

The advertisement management system 108 is configured to modify a result of the maximum flow calculations, such that the advertisement inventory is allocated fairly and evenly, while maintaining the maximum flow. The advertisement management system 108 is configured to manage advertisement overbooking to make the allocation fair among advertisers 112 and 114, and to manage allocation smoothing to make the allocation even among multiple advertisement slots. Advertisement overbooking, allocation smoothing, and management of such overbooking and smoothing are described below.

Advertisement overbooking arises when the advertisement management system 108 receives advertisement reservations 110a and 110b that each requests more advertisement impressions to be delivered at an advertisement slot 102 than advertisement management system 108 can allocate to the advertisement reservation 110a and 110b, respectively. Thus, the advertisement management system 108 receives an “overbook” of advertisement impressions. To fairly satisfy the overbooked reservations 110a and 110b, the advertisement management system 108 satisfies each of the overbooked reservations 110a and 110b at substantially the same percentage, unless doing so results in reducing the total number of advertisement impressions allocated.

For example, the advertisement management system 108 receives the advertisement reservation 110a requesting 600 advertisement impressions at advertisement slot 102, and the advertisement reservation 110b requesting 400 advertisement impressions at advertisement slot 102. The advertisement management system 108 determines that an advertisement inventory includes 400 projected advertisement impressions, the advertisement management system 108 allocate 240 of the 400 projected advertisement impressions to the advertisement reservation 110a, and allocates 160 of the 400 projected advertisement impressions to the advertisement reservation 110b, such that each of the advertisement reservation 110a and advertisement reservation 110b is forty percent satisfied, unless doing so will affect the maximum flow.

Allocation smoothing can be introduced when the advertisement management system 108 receives an advertisement reservation 110a that requests advertisement impressions on a first advertisement slot 102 and a second advertisement slot 116 in aggregation, or advertisement reservation 110b that requests advertisement impressions on advertisement slot 116 that can be divided into sub-slots. The advertisement slot 116 can be divided into sub-slots when the advertisement slot 116 is associated with multiple selection criteria. A selection criterion is a set of one or more aspects that can be used to identify a subset of users from a general user pool. A selection criterion can include time, geography, language, behavioral segment, demographic group, frequency cap, domain, or a keyword. Each sub-slot of the advertisement slot 116 is the advertisement slot 116 associated with one or more selection criteria. The selection criteria can be tiered.

For situations in which systems discussed herein may collect or make use of personal information about users, the users may be provided with opportunities to control whether and/or how such information is collected and used. In addition, certain data may be anonymized in one or more ways before it is stored or used, so that personally identifiable information is removed. For example, a user's identity may be anonymized so that no personally identifiable information can be determined for the user, or a user's geographic location may be generalized where location information is obtained, so that a particular location of a user cannot be determined.

For example, advertisement management system 108 receives the advertisement reservation 110a that include a request of 600 advertisement impressions at advertisement slot 116 that, according an advertisement package defined by the advertisement management system 108, is associated with an audience “people of gender A from states X, Y, and Z.” The advertisement slot 116 can be divided into three sub-slots associated with “people of gender A from state X,” “people of gender A from state Y,” and “people of gender A from state Z.” The sub-slots correspond to projected advertisement impressions of 200, 400, and 600, respectively.

The advertisement management system 108 allocates the requested advertisement impressions evenly among the sub-slots. In an even allocation, the reserved advertisement impressions are allocated to the sub-slots proportionally to the projected advertisement impression of each sub-slot, while maintaining the maximum flow. Using the example above, the advertisement management system 108 satisfies the advertisement reservation 110a in the following manner: allocating 100 advertisement impressions at the sub-slot related to “people of gender A from state X,” 200 advertisement impressions at the sub-slot related to “people of gender A from state Y,” and 300 advertisement impressions at the sub-slot related to “people of gender A from state Z.”

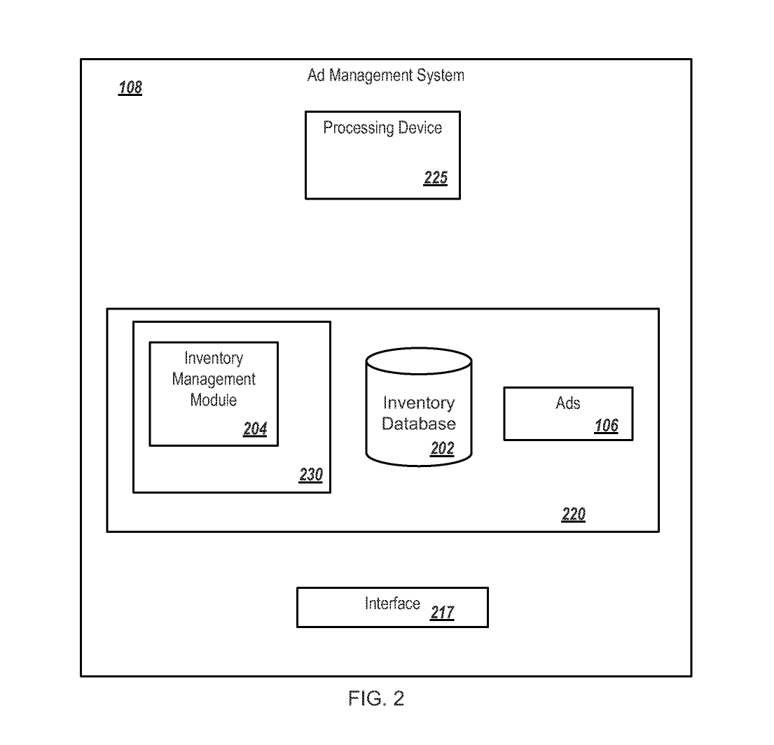

FIG. 2 is a block diagram illustrating subsystems of example advertisement management system 108. The advertisement management system 108 includes a processing device 225 that is programmed to facilitate management of advertisement overbooking and allocation smoothing. In addition, the advertisement management system 108 includes a storage device 220. The storage device 220 stores instructions 230, advertisement inventory database 202, and one or more advertisements 106. Instructions 230 includes inventory management module 204. The processing device 225 can execute instructions 230 to allocate advertisement inventory to reservations and deliver the advertisements 106 in a web page (e.g., web page 104 of FIG. 1) to a user device. These advertisements 106 can include a rectangular banner ad, an audio ad, a video clip, or any other media, content, or interactive advertisement to place along with publisher content in the web page.

The advertisement inventory database 202 stores information on one or more advertisement slots and one or more selection criteria. The information can include projected advertisement impressions. The projected advertisement impressions can be calculated based on project page views of content in which advertisement slots is located.

The advertisement management system 108 also includes an interface 217 for communicating with advertisers and user devices. The interface 217 is configured to allow advertisers to perform availability queries and to place reservations. An availability query is a query that examines whether an advertisement reservation requesting a specified quantity of advertisement impressions at an advertisement slot can be satisfied by projected advertisement impression at the advertisement slot.

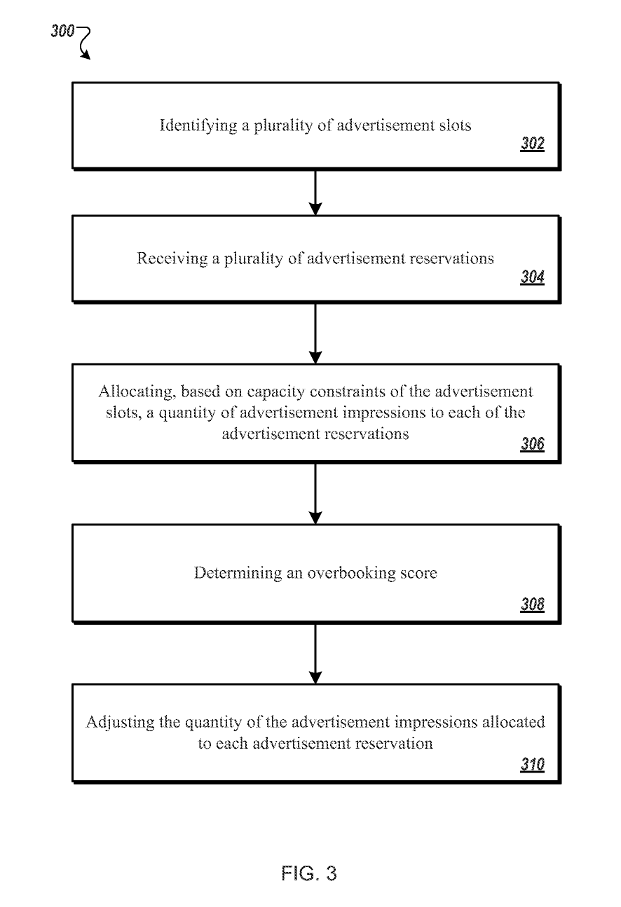

FIG. 3 is a flowchart illustrating an example process 300 of managing inventory overbooking. An advertisement management system identifies (302) multiple advertisement slots. Each of the advertisement slots is associated with a capacity constraint. The capacity constraint includes a limit on number of advertisement impressions that will be displayed at the advertisement slot. The capacity constraint of an advertisement slot corresponds to a projected number of advertisement impressions available at the advertisement slot.

The system receives (304) multiple advertisement reservations. Each of the advertisement reservations requests advertisement impressions at one or more of the advertisement slots. Each of the advertisement reservations can be associated with one or more targeting criteria.

The system allocates (306), based on capacity constraints of the advertisement slots, a quantity of advertisement impressions to each of the advertisement reservations. Allocating the advertisement impressions can be based on requested advertisement impressions in one or more competing reservations. Competing reservations are advertisement reservations made on the same advertisement slot. The competing reservations can be associated with targeting criteria that conflict with one another. For example, a first reservation can request advertisements at an advertisement slot with a targeting criterion “people of gender A from states X, Y, and Z.” A second reservation can request advertisements at the same advertisement slot with a targeting criterion “people from states X, Y, and Z between age M and age N.” The two targeting criteria overlap and conflict with each other. The system can apply various conventional techniques to calculate the number of the advertisement impressions to be allocated among reservations. Some example conventional techniques include greedy algorithms, maximum flow algorithms, and linear programming. For example, allocating the quantity of the advertisement impressions to each of the advertisement reservations can include performing a maximum flow analysis on a directional graph representing the advertisement reservations, the advertisement slots, and advertisement impressions projected to be available through each of the advertisement slots.

The system calculates (308) an overbooking score for each of the advertisement reservations. The overbooking score indicates a degree at which the advertisement reservation is satisfied by the quantity of advertisement impressions allocated to the advertisement reservation. A higher overbooking score indicates a lower degree of satisfaction. The overbooking score is calculated based at least in part on a ratio between a quantity of advertisement impressions requested by an advertisement reservation and the quantity of advertisement impressions allocated to the advertisement reservation.

The system adjusts (310) the quantity of the advertisement impressions allocated to each advertisement reservation so as to minimize a maximum overbooking score while maintaining a maximum total allocation. The maximum total allocation is a maximum number of advertisement impressions that can be allocated to the advertisement reservations, given the capacity constraints and a quantity of advertisement impressions requested by each advertisement reservation. The maximum total allocation includes a sum of the quantity of advertisement impressions allocated to each advertisement reservation. The maximum total allocation can correspond to a result of maximum flow calculations of allocating the advertisement inventory to various reservations.

In some implementations, example process 300 includes receiving an availability query from an advertiser inquiring availabilities of advertisement impressions at an advertisement slot. In response to the availability query, the system provides for display a value representing the adjusted quantity of the advertisement impressions.

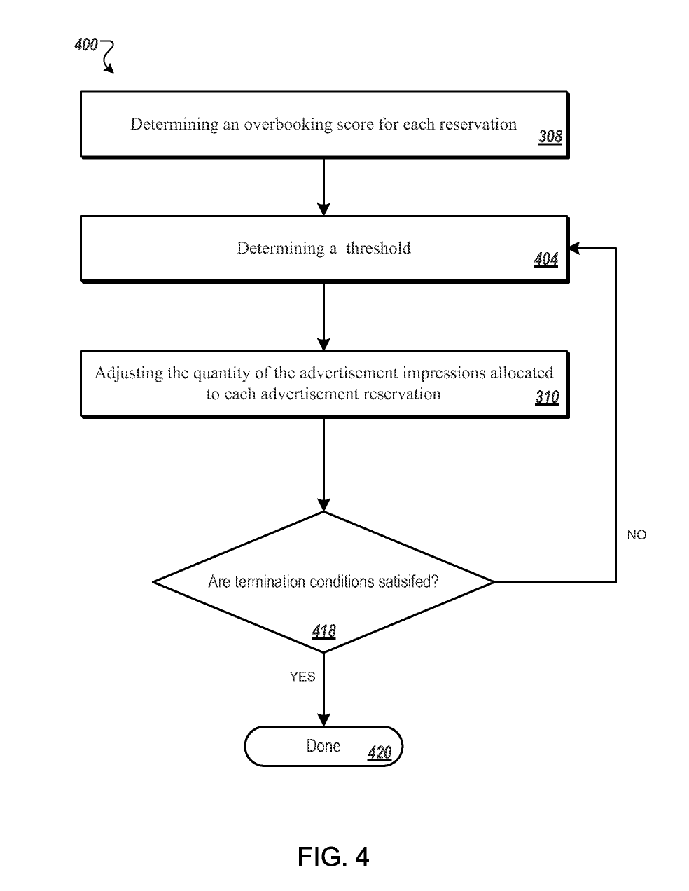

In some implementations, determining (308) the overbooking score and adjusting (310) the quantity of the advertisement impressions allocated to each advertisement reservation can be performed iteratively so as to minimize a maximum overbooking score while maintaining a maximum total allocation. The iterative process is described below in reference to FIG. 4.

FIG. 4 is a flowchart illustrating an example process 400 of iteratively minimizing a maximum overbooking score. An advertisement management system applies a set of heuristics to rectifying the most unfair allocation by reducing the maximum overbooking fraction to as low as possible, and then reduce the second largest overbooking fraction to as low as possible, and so on, until further reduction will reduce the total number of advertisement impressions delivered.

The system calculates (308) an overbooking score of each advertisement reservation. For example, a first reservation P1 reserves 1,000 impressions on advertisement slot S1. A second reservation P2 requests 500 impressions on the same advertisement slot S1. According to a projection, 600 impressions are available from slot S1. An initial allocation can correspond to a result of a maximum flow algorithm. In the initial result of the maximum flow calculations, 200 advertisement impressions are allocated to P1, and 400 advertisement impressions are allocated to P2. The overbooking fraction for reservation P1 is 5.0 (1,000/200). The overbooking fraction for reservation P2 is 1.25 (500/400).

The system determines (404) a threshold. The system can determine an initial threshold for the overbooking scores. The system examines each reservation under the initial threshold and determines whether, under the initial threshold, any adjustments can be made to the reservation being examined to improve the overall reservations. The system adjusts (310) the quantity of the advertisement impressions allocated to each advertisement reservation, if an adjustment to that reservation can be made without negatively affecting the overall reservations. If an adjustment cannot be made on a given reservation, the reservation can be designated as critical. The system can identify all critical reservations, and determine a new threshold for all reservations that have not reached critical value.

The system determines (418) whether one or more termination conditions are satisfied. If the termination conditions are satisfied, example process 400 terminates (420). Otherwise, the system repeats the process 400. In some implementations, the termination conditions are satisfied when the system has examined advertisement impression allocation to each advertisement reservation that has an overbooking fraction greater than one. In some implementations, the termination conditions are satisfied when the system determines that a reallocation reduces a total number of advertisement impressions delivered.

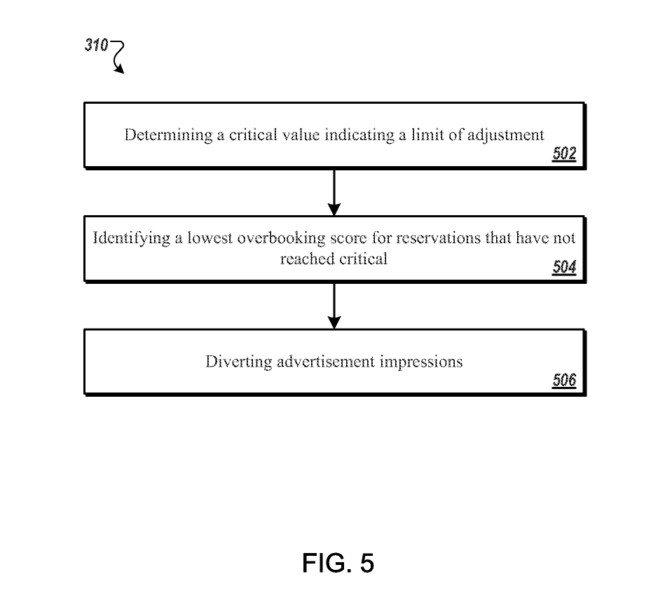

FIG. 5 is a flowchart illustrating an example process 310 of adjusting the quantity of the advertisement impressions allocated to each advertisement reservation. An advertisement management system determines (502) a critical value indicating a limit of adjustment that, if exceeded, the maximum total allocation will decrease.

The system identifies (504) a lowest overbooking score for advertisement reservations that have not reached the critical value. Determining the critical value includes representing the advertisement reservations, advertisement allocations, and advertisement slots in a directional graph. The advertisement allocations are represented as flows on edges of the graph. The capacity constraints are represented as flow limitations of the edges of the graph. The system determines the critical value based on the flow limitations.

The system diverts (506) advertisement impressions allocated to one or more other advertisement reservations to the least satisfied advertisement reservation, based at least in part on the critical value. Diverting advertisement impressions can be achieved through adjusting at least one of the flow limitations of a graph representing the inventory allocation. The system then adjusts the quantity of the advertisement impressions based on the adjusted flow limitation. The adjustment is to reduce the maximum overbooking score as much as possible.

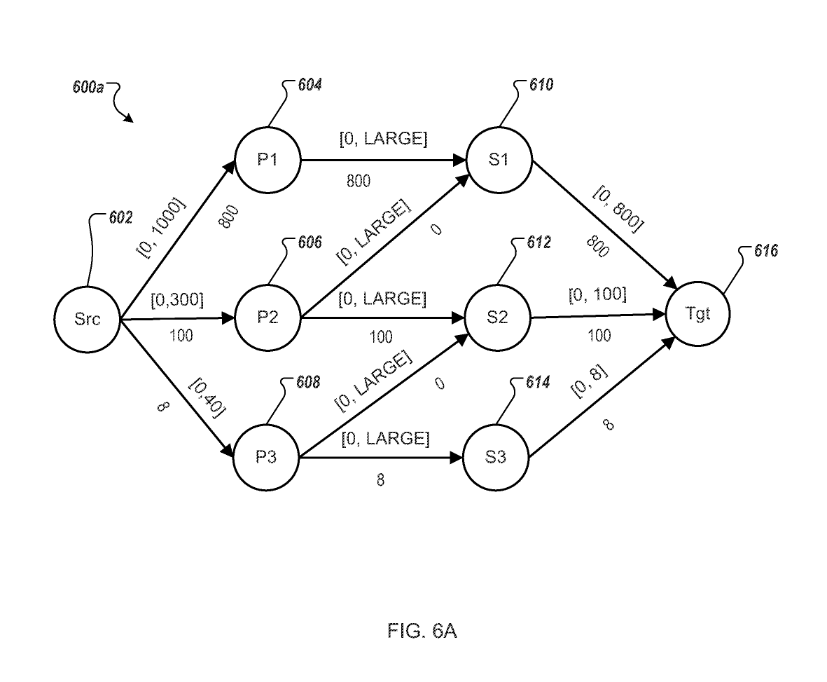

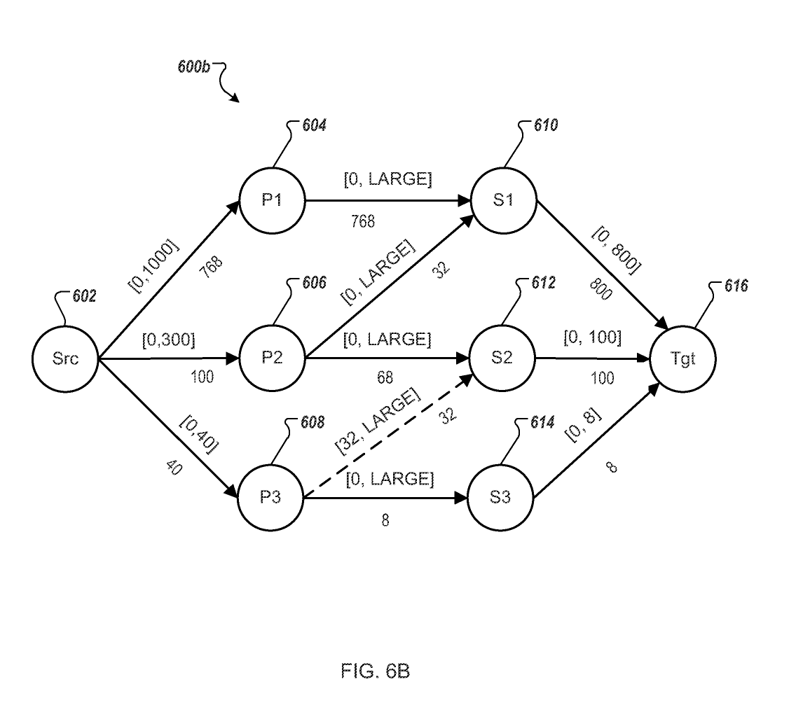

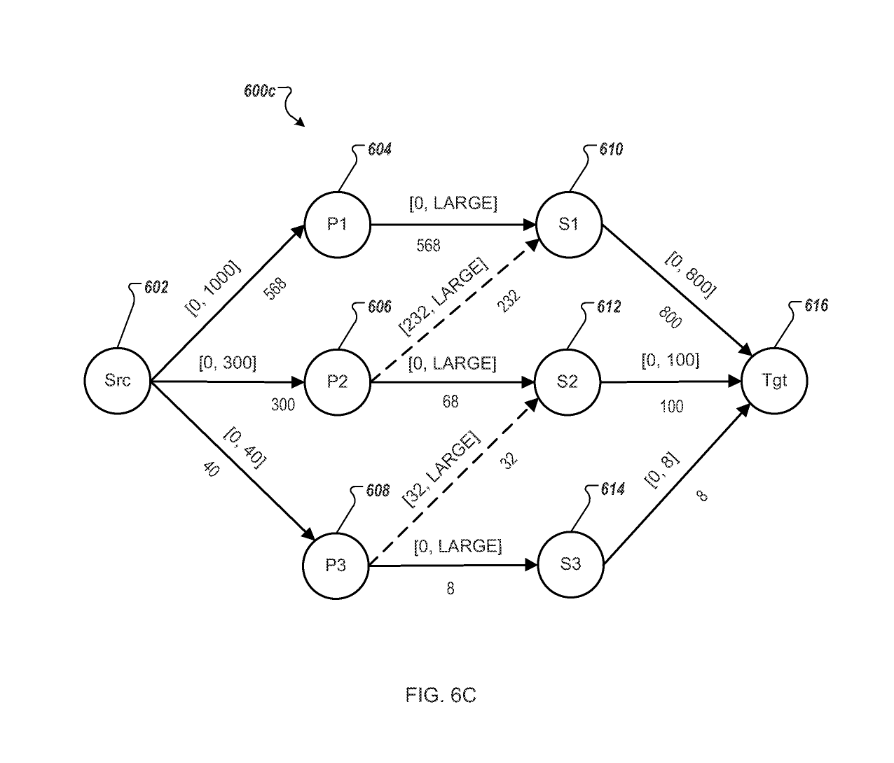

FIGS. 6A-6C are example inventory allocation graphs 600a-c. Inventory allocation graphs 600a-c illustrate example stages of managing inventory overbooking. In the example, an advertisement management system receives three advertisement reservations P1, P2, and P3. The advertisement reservation P1 requests 1,000 advertisement impressions at advertisement slot 51, which has a capacity constraint of 800 impressions. The advertisement reservation P2 requests 300 advertisement impressions on at advertisement slots S1 and S2 in aggregation. Advertisement slot S2 has a capacity constraint of 100 impressions. The advertisement reservation P3 requests 40 advertisement impressions on at advertisement slots S2 and S3 in aggregation. The advertisement slot S3 has a capacity constraint of 8. A reservation on multiple advertisement slots is also referred to as a reservation on a placement, where the placement includes an advertisement slot or an aggregation of multiple advertisement slots.

FIG. 6A is a graph 600a illustrating an initial stage of impression reservations. Graph 600a includes slot nodes 610, 612, and 614 that represent advertisement slot S1, S2, and S3, respectively. In some implementations, slot nodes 610, 612, and 614 can each represent an advertisement slot in association with one or more targeting criteria. Graph 600a includes reservation nodes 604, 606, and 606 that represent advertisement reservations P1, P2, and P3, respectively. A reservation on multiple advertisement slots is also referred to as a reservation on a placement, where the placement includes a combination of one or more advertisement slots.

A source node 602 is added to the graph 600a. Directional edges from the source node 602 and the reservation nodes 604, 606, and, and 608 indicate that impressions are requested in the advertisement reservations P1, P2, and P3, respectively. Each of the directional edges is associated with one or more flow limitations (e.g., [0, 300]). The flow limitations include a lower limit specifying a minimum required amount of flow, or minimum number of advertisement impressions to be allocated to a reservation, and an upper limit specifying a maximum number of impressions to be allocated to the reservation. The lower limit can be zero. The upper limit can equal to a quantity of advertisement impressions requested in an advertisement reservation.

A target node 616 is added to the graph 600a. Directional edges from slot nodes 610, 612, and 614 to the target node 616 each indicates that a quantity of advertisement impressions are allocated at a respective advertisement slot. Each of the edges can have a lower limit of zero and an upper limit that corresponds to a capacity constraint of the corresponding advertisement slot. In various implementations, the capacity constraint can be a projection of advertisement impressions over a specified period of time or on an indefinite period of time. The indefinite period of time can be the life span of the advertisement slot.

A value of the flow on an edge between the source node 602 and a reservation node represents a number of advertisement impressions to be allocated to the reservation represented by the reservation node. A value of the flow on an edge between a slot node and the target node 616 represents a number of advertisement impressions allocated at the advertisement slot represented by the slot node.

In the example, the total number of advertisement reservations is 1,340 (1,000 for P1, 300 for P2, and 40 for P3). The advertisement inventory is overbooked. The sum of all capacity constraints is 908 (800 for S1, 100 for S2, and 8 for S3). A conventional maximum flow calculation can be applied on graph 600a to determine an initial feasible allocation that allocates a maximum number of advertisement impressions. After applying the conventional maximum flow calculation, an example allocation is found. In the example allocation from the conventional maximum flow calculation, 800 advertisement impressions are allocated to the reservation P1, 300 for P2, and 8 on P3. As a result, 800 of the 1,000 reservations on P1, 100 of the 300 reservations on P2, and 8 of the 40 reservations on P3 are satisfied. The system will find another allocation that, without reducing the maximum flow (908 total advertisement impressions), redistributes the advertisement allocations more fairly.

To improve the fairness of the allocation, the system can start from the most unfair allocation and determine whether it is feasible to improve the fairness. The system calculates an overbooking score for each reservation. The overbooking score for reservation P3 is 40/8=5. The overbooking score for reservation P2 is 300/100=3. The overbooking score for reservation of P1 is 1,000/800=1.25. The allocation corresponding to reservation P3 has the highest overbooking score, and designated as the most unfair. The system can identify the most unfair allocation by performing a binary search of all reservations and allocations and identifying the one with the highest overbooking fraction value.

The system performs heuristics to determine whether the most unfair allocation can be improved by pushing down the overbooking fraction value of the most unfair allocation. Upon identifying a most unfair allocation, the system adjusts one or more allocations. The adjustment includes adjusting the capacities of edges between one or more reservation nodes (e.g., reservation node 608) and the slot nodes (e.g., slot nodes 612 and 614).

FIG. 6B is a graph 600b that represents another stage of managing inventory overbooking. In graph 600b, a critical edge (P3, S2) is identified. The critical edge (P3, S2) is an edge on which if a flow is increased, the maximum overbooking score is lowered, indicating that a most unfair allocation will become fairer. The system increases the lower limit of the identified critical edge, until if the lower capacity reaches a value, which if increased by one unit, the total number of delivered impressions will decrease. The value is designated as a critical value. To illustrate, if the lower capacity of edge (P2, S2) is increased to 33, the flow from node 614 to node 616 can have a maximum value of 7 (40−22=7). The total flow therefore can be at most 907 instead of 908. The critical value is 32.

In some implementations, identifying a critical edge from node 608 includes determining an augmenting path from the node 608 to an advertisement slot that pushes more flow (e.g., 33) than needed (e.g., 32) to satisfy the lower limit (e.g., 33). The critical value is assigned to the critical edge. The system sets the lower capacity of the critical edge (P3, S2) to the critical value (32), and re-computes the maximum flow. The critical edge is represented using dashed line in graph 600b and subsequent figures. The system determines a new allocation that maintains the maximum flow. For example, the new maximum flow allocation based on graph 600b can be allocating 768 advertisement impressions to reservations P1, 100 to P2, and 40 to P3. The new allocation provides the same total number of advertisement impressions (768+100+40=908). The new allocation allocates advertisement impressions more fairly than the solution in FIG. 6A. In the new solution, the most unfair allocation has an overbooking score value of 3, which is for the reservation P2, down from 5 of FIG. 6A.

FIG. 6C is a graph 600c that represents a final stage of managing inventory overbooking. The system iterates through one or more advertisement reservations whose overbooking fraction value is greater than one. For example, in an iteration stage, the system again identifies a highest overbooking score, which is for reservation P2, which equals 3. The system identifies a critical edge (P2, S1), a critical value (“232”) and assigns the critical value as the lower capacity of the critical edge. In FIG. 6C, the same total number (908) of advertisement impressions are delivered to advertisers. The overbooking score for reservations P2 and P3 are both 1.0, indicating the advertisement impressions requested, 300 and 40, respectively, are both completely satisfied. For the 1,000 advertisement impressions requested in reservation P1, 568 advertisement impressions are allocated, resulting in an overbooking score of 1,000/568≈1.761, which is an improvement over the initial allocation where the maximum overbooking fraction is 5.

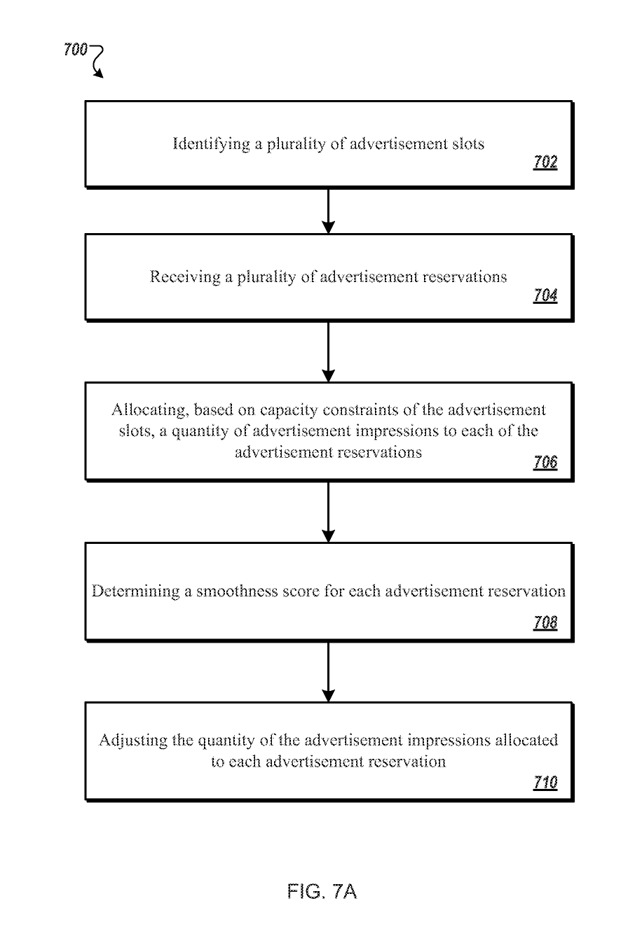

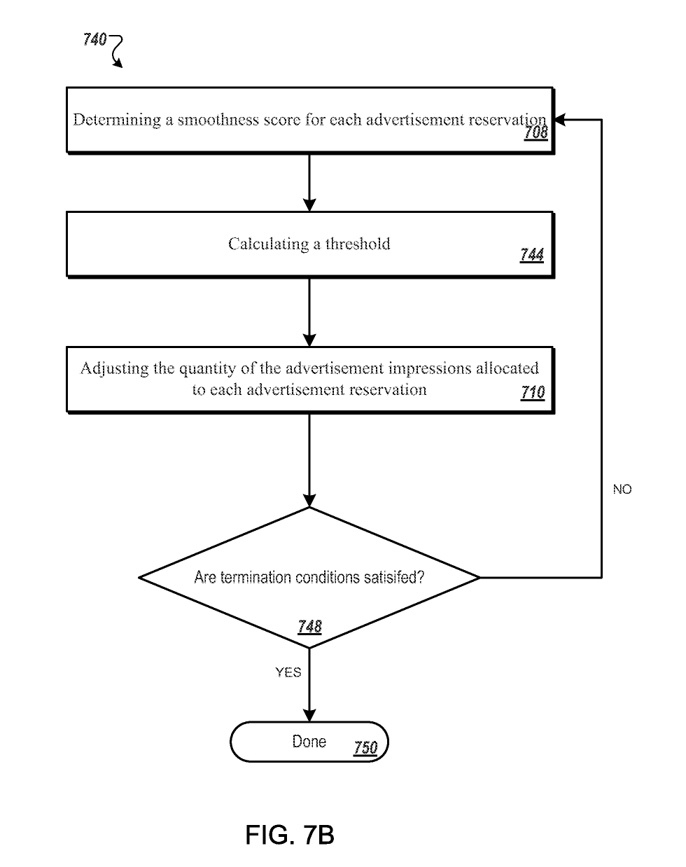

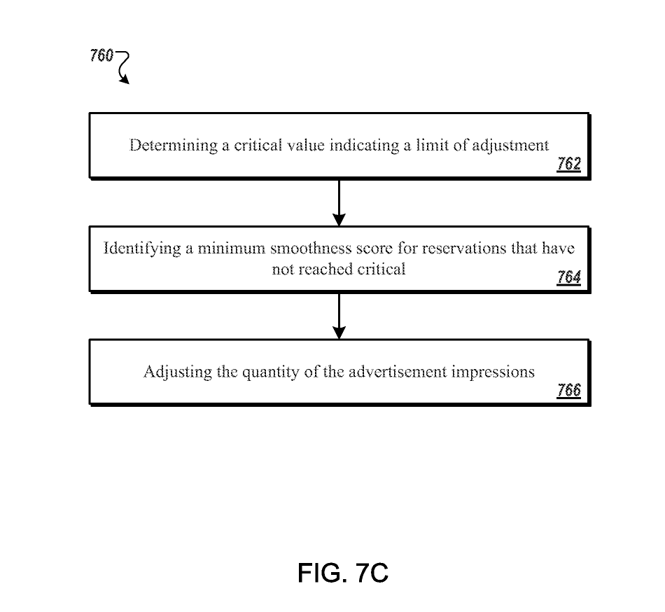

FIG. 7A is a flowchart illustrating an example process 700 of allocation smoothing. An advertisement management system identifies (702) multiple advertisement slots. Each of the advertisement slots is associated with a capacity constraint. The capacity constraint includes a limit on number of advertisement impressions that will be displayed at the advertisement slot. The capacity constraint of an advertisement slot corresponds to a projected number of advertisement impressions that will be displayed at the advertisement slot.

The system receives (704) multiple advertisement reservations. Each of the advertisement reservations requests advertisement impressions at one or more of the advertisement slots. Each of the advertisement reservations can be associated with one or more targeting criteria.

The system allocates (706), based on capacity constraints of the advertisement slots, a quantity of advertisement impressions to each of the advertisement reservations. Allocating the advertisement impressions can be based on requested advertisement impressions in one or more competing reservations. The system can apply various conventional flow calculation techniques to calculate the number of the advertisement impressions to be allocated among reservations. Some example conventional flow calculation techniques include greedy algorithms, maximum flow algorithms, linear programming, and transportation programming. For example, allocating the quantity of the advertisement impressions to each of the advertisement reservations can include performing a maximum flow analysis on a directional graph representing the advertisement reservations, the advertisement slots, and advertisement impressions projected to be available through each of the advertisement slots.

The system determines (708) a smoothness score for each of the advertisement reservations. The smoothness score indicates evenness of advertisement impressions allocated among advertisement slots of the advertisement reservation, wherein a higher smoothness score indicates a more even allocation. Determining the smoothness score includes calculating a smoothness ratio between advertisement impressions allocated to the advertisement reservation at an advertisement slot and an ideal allocation value. The ideal allocation value indicates a smooth allocation corresponding to an advertisement reservation. The system can calculate the ideal allocation value based on a quantity of advertisement impressions requested by the advertisement reservation, the capacity constraint of each advertisement slot at which the advertisement impressions requested by the advertisement reservation, and a total capacity constraint. The total capacity constraint includes a sum of capacity constraint of advertisement slots at which advertisement impressions are requested by the advertisement reservation.

Determining the smoothness score includes determining an allocation threshold value corresponding to the advertisement slot and the advertisement reservation. The threshold value includes a value beyond which an advertisement allocation, although being uneven, is permissible. The system designates one of the threshold value and the smoothness ratio as the smoothness score. In some implementations, the system designates a lesser value between the threshold value and the smoothness ratio as the smoothness score.

For example, a reservation P1 requests, in aggregation, 100 advertisement impressions at advertisement slots S1 and S2, the capacity constraints of which are 900 and 100, respectively. An even allocation is an allocation allocating 90 impressions at S1 and 10 impressions at S2 to reservation P1. However, due to flow calculation constraints (e.g., maximum flow constraints) and fairness constraints, the ideal allocation may not be achievable.

The smoothness score is the lesser of a specified threshold value (e.g., “1”) and a ratio between a quantity of advertisement impressions allocated to a reservation and the ideal allocation. In the above example, if an allocation assigns 30 impressions from S1 and 70 impressions from S2 to reservation P1, the smoothness scores of the two assignments are ⅓ (minimum value between 1 and 30/90) and 1 (minimum value between 1 and 70/10), respectively. If a smoothness score reaches the threshold value, no further smoothing is necessary. The threshold value of “1” indicates that an advertiser is not harmed by being given more than his or her share of advertisement impressions at a particular advertisement slot.

The system adjusts (710) the quantity of the advertisement impressions allocated to each advertisement reservation so as to maximize a minimum smoothness score while maintaining a maximum total allocation. The maximum total allocation is a maximum number of advertisement impressions that can be allocated to the advertisement reservations, given the capacity constraints and a quantity of advertisement impressions requested by each advertisement reservation. The maximum total allocation includes a sum of the quantity of advertisement impressions allocated to each advertisement reservation.

In some implementations, example process 700 is performed subsequent to the example process 300 as described in reference to FIG. 3. In some implementations, example process 700 includes receiving an availability query from an advertiser inquiring availabilities of advertisement impressions at an advertisement slot. In response to the availability query, the system provides for display a value representing the adjusted quantity of the advertisement impressions.

In some implementations, determining (708) the smoothness score and adjusting (310) the quantity of the advertisement impressions allocated to each advertisement reservation can be performed iteratively so as to minimize a maximum smoothness score while maintaining a maximum total allocation. The iterative process is described below in reference to FIG. 7B.

FIG. 7B is a flowchart illustrating an example process 740 of iteratively maximizing a minimum smoothness score. An advertisement management system applies a set of heuristics to rectifying the most uneven allocation by increasing the minimum smoothness score to reach or exceed the allocation threshold value. Alternatively, if reaching or exceeding the allocation threshold value is impossible, the system increases the minimum smoothness score to as close to the allocation threshold value as possible. The system then increases the second lowest smoothness score, and so on, until further increase will reduce the total number of advertisement impressions delivered.

The system determines (708) an overbooking score of each advertisement reservation. The system determines (744) a threshold. The system can determine an initial threshold for the overbooking scores. The system examines each reservation under the initial threshold and determines whether, under the initial threshold, any adjustments can be made to the reservation being examined to make overall allocations more even. The system adjusts (710) the quantity of the advertisement impressions allocated to each advertisement reservation, if an adjustment to that reservation can be made without negatively affecting the overall reservations. If an adjustment cannot be made on a given reservation, the reservation can be designated as critical. The system can identify all critical reservations, and determine a new threshold for all reservations that have not reached critical value.

The system determines (748) whether one or more termination conditions are satisfied. If the termination conditions are satisfied, example process 740 terminates (750). Otherwise, the system repeats the process 740. In some implementations, the termination conditions are satisfied when the system has examined advertisement impression allocation to each advertisement reservation that has a smoothness score less than the allocation threshold value. In some implementations, the termination conditions are satisfied when the system determines that a reallocation reduces a total number of advertisement impressions delivered or increases a minimized maximum overbooking score.

FIG. 7C is a flowchart illustrating an example process 760 of adjusting the quantity of the advertisement impressions allocated to each advertisement reservation. An advertisement management system determines (762) critical value indicating a limit of adjustment that, if exceeded, the maximum total allocation will decrease.

The system identifies (764) a highest smoothness score for advertisement reservations that have not reached the critical value. Determining the critical value includes representing the advertisement reservations, advertisement allocations, and advertisement slots in a directional graph. The advertisement allocations are represented as flows on edges of the graph. The capacity constraints are represented as flow limitations of the edges of the graph. The server determines the critical value based on the flow limitations.

The system adjusts (766) the quantity of the advertisement impressions allocated to the advertisement reservation of the least smooth advertisement allocation, based at least in part on the critical value. Adjusting the quantity of advertisement impressions can be achieved through adjusting at least one of the flow limitations of a graph representing the inventory allocation. The system then adjusts the quantity of the advertisement impressions based on the adjusted flow limitation. The adjustment increases the minimum smoothness score and maintains the maximum total allocation.

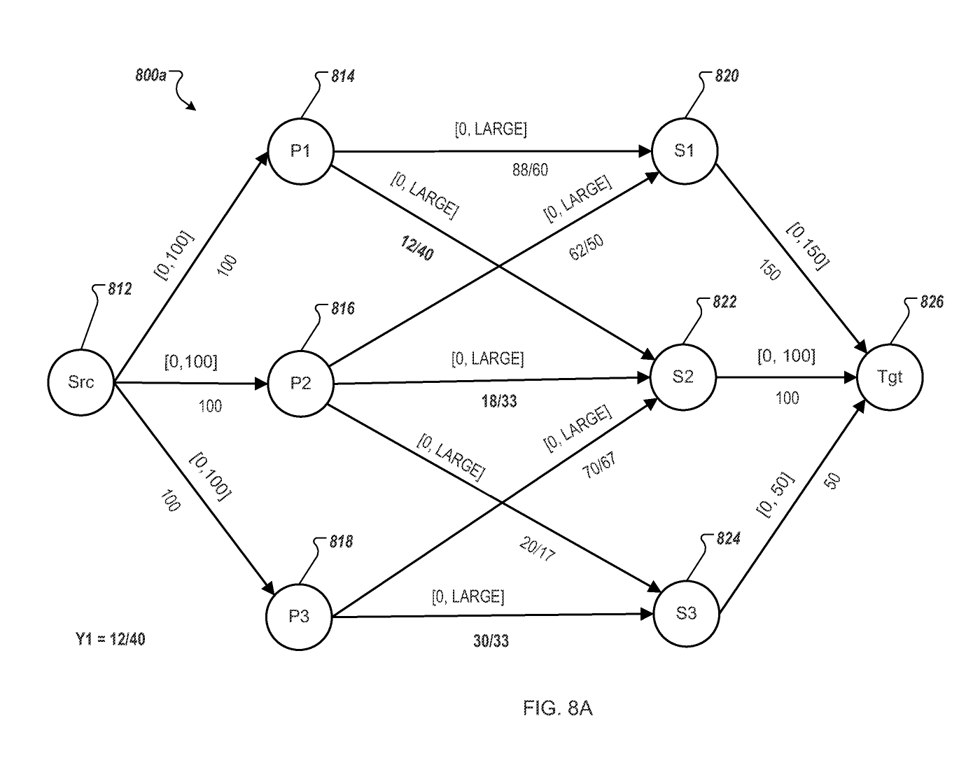

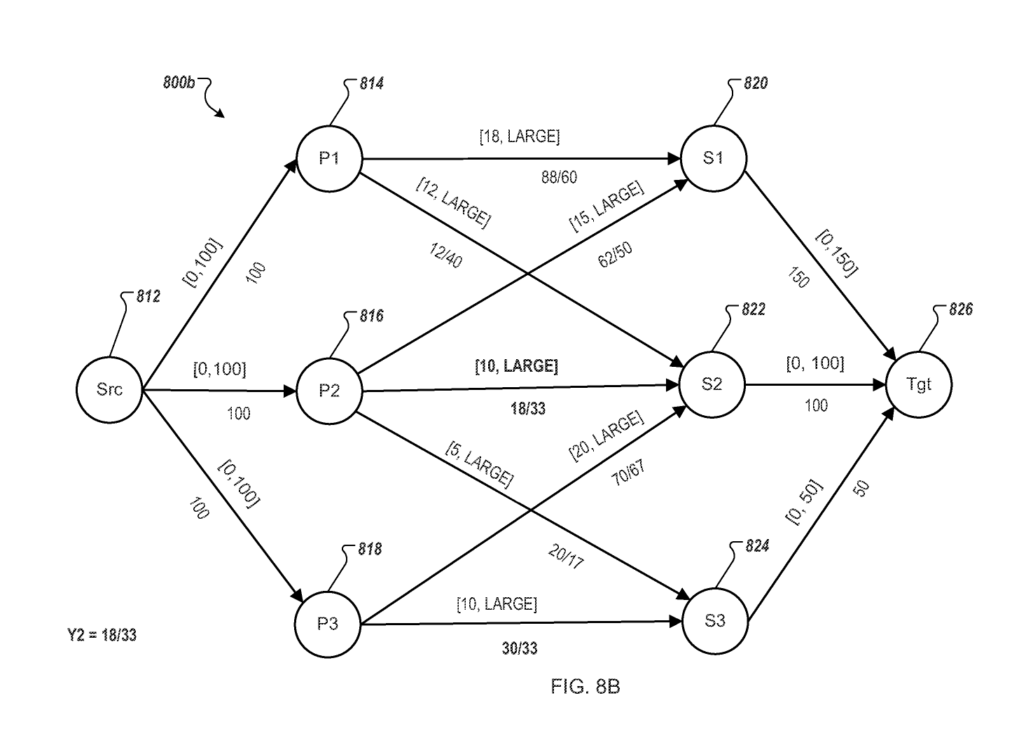

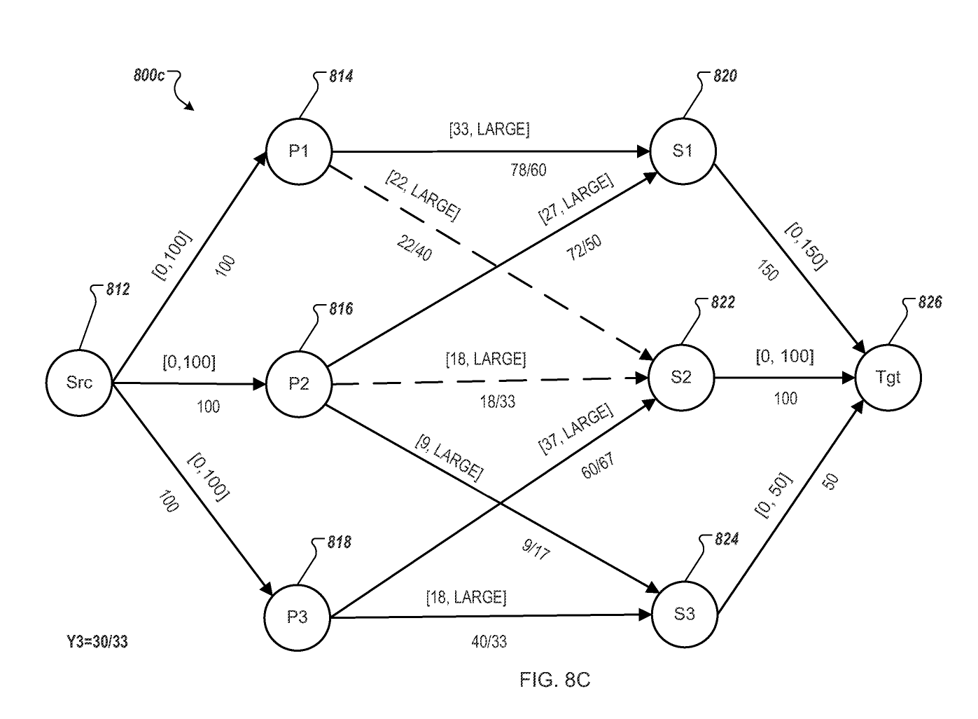

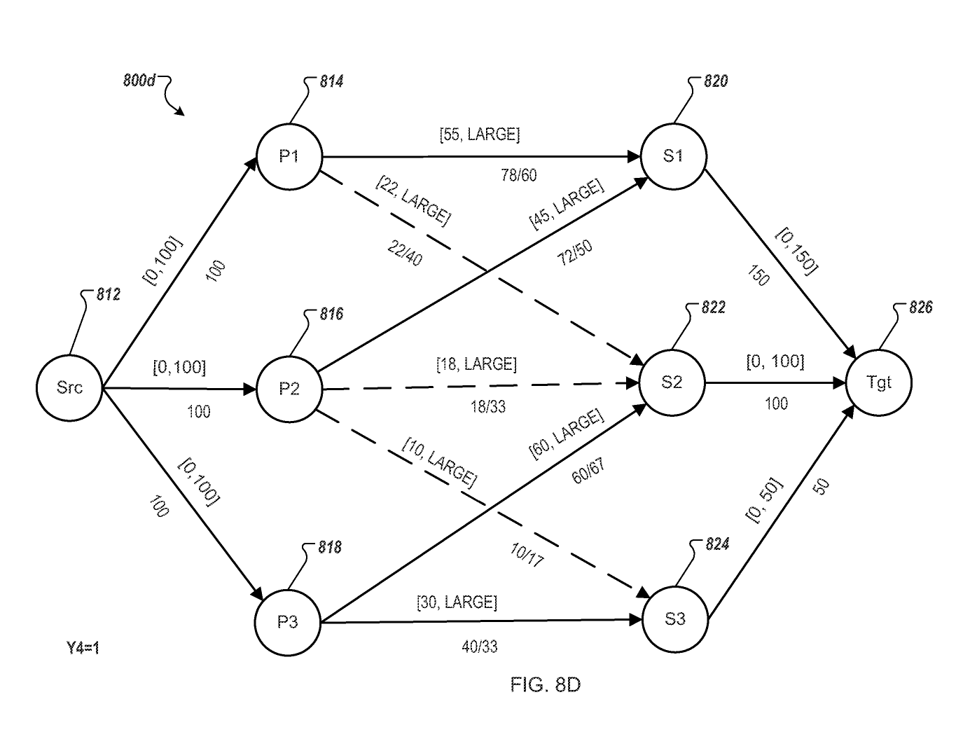

FIGS. 8A-8D are example inventory allocation graphs 800a-d. Inventory allocation graphs 800a-d illustrate example stages of managing allocation smoothing. In the example, an advertisement management system receives three advertisement reservations P1, P2, and P3. The advertisement reservation P1 requests 100 advertisement impressions at advertisement slots S1 and S2 in aggregation. The advertisement reservation P2 requests 100 advertisement impressions at advertisement slots S1, S2, and S3 in aggregation. The advertisement reservation P3 requests 100 advertisement impressions at advertisement slots S2 and S3 in aggregation. The advertisement slot S1 has a capacity constraint of 150 impressions. The advertisement slot S2 has a capacity constraint of 100 impressions. The advertisement slot S3 has a capacity constraint of 50.

FIG. 8A is a graph 800a representing a stage of managing allocation smoothing. Reservation nodes 814, 816, and 818 represent the advertisement reservations P1, P2, and P3, respectively. Slot nodes 820, 822, and 824 represent advertisement slots S1, S2, and S3, respectively. Source node 812 and target node 826 are added. In this example, all advertisement reservations are satisfied.

In an ideal smooth allocation, an advertisement reservation at multiple advertisement slots is assigned at each advertisement slot a quantity of advertisement impressions that is proportional to the capacity constraint of the advertisement slot. For example, an ideally smooth allocation of advertisement inventory to advertisement reservation P1, which requests 100 advertisement impressions, is allocating 60 impressions at S1 and 40 impressions at S2 (60:40=150:100). A smooth allocation to the request of the 100 advertisement impressions in advertisement reservation P2 is allocating 50 impressions at S1, 33 impressions at S2, and 17 impressions at S1. A smooth allocation to the request of the 100 advertisement impressions in advertisement reservation P3 is allocating 67 impressions at S2 and 33 impressions at S3. However, such ideal smooth allocations are not always feasible. For example, S2, having a capacity constraint of 100, cannot deliver 40+67+33=140 advertisement impressions allocated at S2 according to the ideal smooth allocation.

In FIG. 8A, a feasible allocation resulting from a flow calculation is represented. The allocation is represented using numbers below the edges between reservation nodes 814, 816, 818 and slot nodes 820, 822, and 824. The first number under each edge between a reservation node and a slot node represents a part of the allocation to the flow calculation, indicating number of advertisement impressions at the advertisement slot represented by the slot node to the advertisement reservation represented by the reservations node. For example, the number “88” under edge (P1, S1) indicates that 88 advertisement impressions at advertisement slot S1 are assigned to the reservation P1. The second number under each edge (e.g., the number “60” under edge (P1, S1)) represents an ideal allocation, e.g., the number of advertisement impressions allocated according to the ideal smooth allocation.

The system will smooth the allocation by improving the smoothness of the least smooth edge. The smoothness of an edge is measured using a smoothness score. For example, the smoothness score of edge (P1, S3), designated as Y1, is 0.3 (12/40=0.3). If the smoothness score equals one, the allocation is smooth. The system will iterate through the edges to maximize the minimum smoothness score. In this example, three edges (edges (P1, S2), (P2, S2), and (P3, S3)) are associated with smoothness score less than one. The system will specify minimum capacities on these edges in order to smooth the allocation.

The system starts from an edge with the lowest smoothness score and used the lowest smoothness score to calculate a lower capacity for every edge between a reservation node and a slot node. In the example shown, edge (P1, S2) has the lowest smoothness score (0.3). The lower capacity on each edge is calculated by multiplying the ideal allocation value on that edge with the least smooth fraction. For example, the lower capacity of each edge is set according to Table 1 below:

TABLE 1

| Edge | Ideal Flow | New Lower Capacity |
|---|---|---|
| P1, S1 | 60 | 18 |
| P1, S2 | 40 | 12 |
| P2, S1 | 50 | 15 |
| P2, S2 | 33 | 10 |
| P2, S3 | 17 | 5 |
| P3, S2 | 67 | 20 |
| P3, S3 | 33 | 10 |

The system recalculates the maximum flow to determine that (1) the lower capacity setting is feasible and (2) the total flow is not reduced. An allocation is found, and is shown below in FIG. 8B.

FIG. 8B is a graph 800b illustrating another stage in managing allocation smoothing. The system moves to an edge that has the next lowest smoothness score. The edge is (P2, S2). The smoothness score on edge (P2, S2), designated as Y2, is 18/33. The system then uses the next lowest smoothness score smoothness score to calculate a lower capacity for every edge between a reservation node and a slot node.

New lower capacity for each edge between a reservation node and a slot node is calculated. In the calculation in the stage of FIG. 8B, as well as in every stage before or after this stage, the system limits the lower capacity of each edge to a critical value, to avoid reducing the total flow (e.g., the total advertisement impressions delivered). The following is a table of lower capacities, taking into consideration of the critical values of each edge.

TABLE 2

| Edge | Ideal Flow | New Lower Capacity |
|---|---|---|
| P1, S1 | 60 | 33 |
| P1, S2 | 40 | 22* |
| P2, S1 | 50 | 27 |
| P2, S2 | 33 | 18* |
| P2, S3 | 17 | 9 |
| P3, S2 | 67 | 37 |
| P3, S3 | 33 | 18 |

The system recalculates the maximum flow to determine that (1) the lower capacity setting is feasible and (2) the total flow is not reduced. The lower capacity on edge (P1, S2) is limited by the critical value. An allocation is found, and is shown below in FIG. 8C.

FIG. 8C is a graph 800c illustrating another stage in managing allocation smoothing. The system moves to an edge that has the next lowest smoothness score. In this stage, the edge is (P3, S3). The lowest smoothness score, designated as Y3, is 30/33. The system uses the smoothness score to calculate a new lower limit for every edge between a reservation node and a slot node.

In the calculation in the stage of FIG. 8C, as well as in every stage before or after this stage, the system limits the lower capacity of each edge to a critical value, to avoid reducing the total flow (e.g., the total advertisement impressions allocated). The following is a table of lower capacities, taking into consideration of the critical values of each edge.

TABLE 3

| Edge | Ideal Flow | New Lower Capacity |
|---|---|---|
| P1, S1 | 60 | 55 |
| P1, S2 | 40 | 22* |
| P2, S1 | 50 | 45 |
| P2, S2 | 33 | 18* |
| P2, S3 | 17 | 10* |
| P3, S2 | 67 | 60 |
| P3, S3 | 33 | 30 |

The system recalculates the maximum flow. The system determines that edges (P1, S2) (P2, S2), and (P2, S3) each has a lower capacity that reaches a critical value (22, 18, and 10, respectively, marked with asterisks in Table 3 above). A further increase of lower capacity will result in a reduction of the total flow. The lower capacities on these edges are fixed at the critical value. The edges whose lower flow limit has reached critical value are represented as dashed lines in FIG. 8D.

FIG. 8D is a graph 800d illustrating a stage in managing allocation smoothing. The next lowest smoothness score is greater 1. The allocation for each edge is represented under the edge in graph 800d. The system designates the flow, as shown in graph 800d, as a result of smoothing.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, a personal computer system, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, or in general any type of computing or electronic device, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program can, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, a network routing device, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or a routing device, e.g., a network router, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs executing on the respective computers and having a client-server relationship to each other. In some embodiments, a server transmits data (e.g., an HTML page) to a user device (e.g., for purposes of displaying data to and receiving user input from a user interacting with the user device). Data generated at the user device (e.g., a result of the user interaction) can be received from the user device at the server.

An electronic document (which for brevity will simply be referred to as a document) can, but need not, correspond to a file. A document can be stored in a portion of a file that holds other documents, in a single file dedicated to the document in question, or in multiple coordinated files.

While this specification contains many specific implementation details, these should not be construed as limitations on the scope of any inventions or of what can be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing can be advantageous. The processes described can be applied to any inventory management, in addition to online advertisement.

What is claimed is:

1. A method executed by one or more computers, comprising:
identifying, by one or more computers, a plurality of advertisement slots, each of the advertisement slots being a portion of a web page configured for the display of advertisements and being associated with a capacity constraint, the capacity constraint specifying a limit on a number of advertisement impressions that will be displayed at the advertisement slot;
receiving, by the one or more computers, a plurality of advertisement reservations, each of the advertisement reservations requesting advertisement impressions at one or more of the advertisement slots;
initially allocating, by the one or more computers and based on the capacity constraints of the advertisement slots, a quantity of advertisement impressions to each of the advertisement reservations producing a first allocation;
after initially allocating, determining, for each of the advertisement reservations and by the one or more computers, an overbooking score specifying a degree at which the advertisement reservation is satisfied by the quantity of advertisement impressions allocated to the advertisement reservation, wherein a higher overbooking score indicates a lower degree of satisfaction, and wherein the overbooking score is determined based at least in part on a ratio between a quantity of advertisement impressions requested by the advertisement reservation and the quantity of advertisement impressions that have been initially allocated to the advertisement reservation;
adjusting, by the one or more computers, the quantity of the advertisement impressions allocated to at least some of the advertisement reservations to produce a second different allocation that provides a reduced a maximum overbooking score while maintaining at least a specified total allocation of advertisement impressions to the advertisement reservations, the specified total allocation including a sum of the quantity of advertisement impressions allocated to each of the advertisement reservations; and
providing, by the computer, a value representing the adjusted quantity of the advertisement impressions.

2. The method claim 1, wherein the capacity constraint corresponds to a projected number of advertisement impressions that will be displayed at the advertisement slot.

3. The method of claim 1, wherein the maximum total allocation is a maximum number of advertisement impressions that can be allocated to the advertisement reservations, given the capacity constraints and a quantity of advertisement impressions requested by each advertisement reservation.

4. (canceled)

5. The method of claim 1, wherein adjusting the quantity of the advertisement impressions allocated to each advertisement reservation comprises:
determining a critical value indicating a limit of adjustment that, if exceeded, the maximum total allocation will decrease;
identifying a lowest overbooking score for advertisement reservations that have not reached the critical value; and
based at least in part on the critical value and the lowest overbooking score, diverting advertisement impressions allocated to one or more other advertisement reservations to one or more advertisement reservations corresponding to the lowest overbooking score.

6. The method of claim 5, wherein determining the critical value comprises:
representing the advertisement reservations, advertisement allocations, and advertisement slots in a directional graph wherein:
the advertisement allocations are represented as flows on edges of the directional graph; and
the capacity constraints are represented as flow limitations of the edges of the directional graph; and
determining the critical value based on the flow limitations.

7. The method of claim 6, wherein the critical value is a minimum required amount of flow on an edge of the directional graph, wherein an increase of the minimum required amount of flow on the edge causes the maximum total allocation to decrease.

8. The method of claim 6, wherein adjusting the quantity of the advertisement impressions allocated to the advertisement reservation comprises:
adjusting at least one of the flow limitations based on the overbooking score; and
adjusting the quantity of the advertisement impressions based on the adjusted flow limitation.

9. The method of claim 1, wherein allocating the quantity of the advertisement impressions to each of the advertisement reservations comprises performing a maximum flow analysis on a directional graph representing the advertisement reservations, the advertisement slots, and advertisement impressions projected to be available through each of the advertisement slots.

10. The method of claim 1, further comprising, in response to an availability query, providing for display a value representing the adjusted quantity of the advertisement impressions.

11. The method of claim 1, wherein determining the overbooking score for each of the advertisement reservations and adjusting the quantity of the advertisement impressions allocated to each advertisement reservation are performed iteratively.

12. A system comprising:
one or more computers configured to perform operations comprising:
identifying a plurality of advertisement slots, each of the advertisement slots being a portion of a web page configured for the display of advertisements and being associated with a capacity constraint, the capacity constraint specifying a limit on a number of advertisement impressions that will be displayed at the advertisement slot;
receiving a plurality of advertisement reservations, each of the advertisement reservations requesting advertisement impressions at one or more of the advertisement slots;
initially allocating, based on the capacity constraints of the advertisement slots, a quantity of advertisement impressions to each of the advertisement reservations producing a first allocation;
after initially allocating, determining, for each of the advertisement reservations, an overbooking score specifying a degree at which the advertisement reservation is satisfied by the quantity of advertisement impressions allocated to the advertisement reservation, wherein a higher overbooking score indicates a lower degree of satisfaction, and wherein the overbooking score is determined based at least in part on a ratio between a quantity of advertisement impressions requested by the advertisement reservation and the quantity of advertisement impressions that have been initially allocated to the advertisement reservation;
adjusting the quantity of the advertisement impressions allocated to at least some of the advertisement reservations producing a second different allocation so as to minimize that provides a reduced maximum overbooking score while maintaining at least a specified total allocation of advertisement impressions to the advertisement reservations, the specified total allocation including a sum of the quantity of advertisement impressions allocated to each of the advertisement reservations; and
providing a value representing the adjusted quantity of the advertisement impressions.

13. The system claim 12, wherein the capacity constraint corresponds to a projected number of advertisement impressions that will be displayed at the advertisement slot.

14. The system of claim 12, wherein the maximum total allocation is a maximum number of advertisement impressions that can be allocated to the advertisement reservations, given the capacity constraints and a quantity of advertisement impressions requested by each advertisement reservation.

15. (canceled)

16. The system of claim 12, wherein adjusting the quantity of the advertisement impressions allocated to each advertisement reservation comprises:
determining a critical value indicating a limit of adjustment that, if exceeded, the maximum total allocation will decrease;
identifying a lowest overbooking score for advertisement reservations that have not reached the critical value; and
based at least in part on the critical value and the lowest overbooking score, diverting advertisement impressions allocated to one or more other advertisement reservations to one or more advertisement reservations corresponding to the lowest overbooking score.

17. The system of claim 16, wherein determining the critical value comprises:
representing the advertisement reservations, advertisement allocations, and advertisement slots in a directional graph wherein:
the advertisement allocations are represented as flows on edges of the directional graph; and
the capacity constraints are represented as flow limitations of the edges of the directional graph; and
determining the critical value based on the flow limitations.

18. The system of claim 17, wherein the critical value is a minimum required amount of flow on an edge of the directional graph, wherein an increase of the minimum required amount of flow on the edge causes the maximum total allocation to decrease.

19. The system of claim 17, wherein adjusting the quantity of the advertisement impressions allocated to the advertisement reservation comprises:
adjusting at least one of the flow limitations based on the overbooking score; and
adjusting the quantity of the advertisement impressions based on the adjusted flow limitation.

20. The system of claim 12, wherein allocating the quantity of the advertisement impressions to each of the advertisement reservations comprises performing a maximum flow analysis on a directional graph representing the advertisement reservations, the advertisement slots, and advertisement impressions projected to be available through each of the advertisement slots.

21. The system of claim 12, the operations further comprising, in response to an availability query, providing for display a value representing the adjusted quantity of the advertisement impressions.

22. The system of claim 12, wherein determining the overbooking score for each of the advertisement reservations and adjusting the quantity of the advertisement impressions allocated to each advertisement reservation are performed iteratively.

23. A non-transitory computer-readable storage device storing instructions operable to cause one or more computers to perform operations comprising:
identifying a plurality of advertisement slots, each of the advertisement slots being a portion of a web page configured for the display of advertisements and being associated with a capacity constraint, the capacity constraint specifying a limit on a number of advertisement impressions that will be displayed at the advertisement slot;
receiving a plurality of advertisement reservations, each of the advertisement reservations requesting advertisement impressions at one or more of the advertisement slots;
initially allocating, based on the capacity constraints of the advertisement slots, a quantity of advertisement impressions to each of the advertisement reservations producing a first allocation;
determining, for each of the advertisement reservations, an overbooking score specifying a degree at which the advertisement reservation is satisfied by the quantity of advertisement impressions allocated to the advertisement reservation, wherein a higher overbooking score indicates a lower degree of satisfaction, and wherein the overbooking score is determined based at least in part on a ratio between a quantity of advertisement impressions requested by the advertisement reservation and the quantity of advertisement impressions that have been initially allocated to the advertisement reservation;
adjusting the quantity of the advertisement impressions allocated to at least some of the advertisement reservations producing a second different allocation that provides a reduced maximum overbooking score while maintaining at least a specified total allocation of advertisement impressions to the advertisement reservations, the specified total allocation including a sum of the quantity of advertisement impressions allocated to each of the advertisement reservations; and
providing a value representing the adjusted quantity of the advertisement impressions.

24. The non-transitory storage device claim 23, wherein the capacity constraint corresponds to a projected number of advertisement impressions that will be displayed at the advertisement slot.

25. The non-transitory storage device of claim 23, wherein the maximum total allocation is a maximum number of advertisement impressions that can be allocated to the advertisement reservations, given the capacity constraints and a quantity of advertisement impressions requested by each advertisement reservation.

26. The method of claim 1, wherein adjusting further comprises identifying a maximum overbooking score of the determined overbooking scores for each of the advertisement reservations, the maximum overbooking score being associated with a first reservation, identifying one or more new allocations that are different from the first allocation, re-calculating an overbooking score for the first reservation for each new allocation, and identifying one of the new allocations as the second different allocation including determining the one that both minimizes the overbooking score of the first reservation while maximizing total allocation.

27. The system of claim 12, wherein adjusting further comprises identifying a maximum overbooking score of the determined overbooking scores for each of the advertisement reservations, the maximum overbooking score being associated with a first reservation, identifying one or more new allocations that are different from the first allocation, re-calculating an overbooking score for the first reservation for each new allocation, and identifying one of the new allocations as the second different allocation including determining the one that both minimizes the overbooking score of the first reservation while maximizing total allocation.

28. The non-transitory storage device of claim 23, wherein adjusting further comprises identifying a maximum overbooking score of the determined overbooking scores for each of the advertisement reservations, the maximum overbooking score being associated with a first reservation, identifying one or more new allocations that are different from the first allocation, re-calculating an overbooking score for the first reservation for each new allocation, and identifying one of the new allocations as the second different allocation including determining the one that both minimizes the overbooking score of the first reservation while maximizing total allocation.
